(19) United States
(12) Patent Application Publication
(10) Pub. No.: US 2010/0153137 A1
(43) Pub. Date: Jun. 17, 2010

(54) MULTIDIMENSIONAL INSURANCE QUOTING SYSTEM AND METHOD

(76) Inventors: Nagaraj V. RAO, Flower Mound, TX (US); Rajendra Guttal, Bangalore (IN)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(21) Appl. No.: 12/332,780

(22) Filed: Dec. 11, 2008

(51) Int. Cl. G06Q 40/00; G06F 15/16; G06F 7/06

(52) U.S. Cl. 705/4; 709/202; 707/E17.014

(57) ABSTRACT

A system, method and computer program product for providing insurance rate quotes comprises a quotation module executable by a processor, the quotation module configured to receive a set of parameter values from a user. The quotation module is also configured to transmit the set of parameter values to least one insurance provider and obtain a rate quote based on the set of parameter values. The quotation module is further configured to vary, transparently to the user, at least one value of the set of parameter values and obtain at least one additional rate quote from the insurance provider based on the varied set of parameter values.

### BACKGROUND

Consumers looking for insurance products (e.g., automobile insurance, health insurance, life insurance, etc.) often turn to the Internet or an insurance broker to obtain an insurance premium estimate (a.k.a., a rate quote). For example, a consumer may use the Internet to connect to the website of an insurance broker via a browser on a network-enabled computer. The consumer then enters one or more desired parameters related to the insurance product (e.g., deductible amount, coverage amount, etc.). After the parameters have been entered, the broker interfaces with different insurance providers and requests an insurance premium estimate or rate quote based on the desired parameters requested by the consumer. The rate quotes are then provided to the consumer.

### BRIEF DESCRIPTION OF THE DRAWINGS

The accompanying drawings incorporated in and forming a part of the specification illustrate several aspects of the present disclosure and, together with the description, serve to explain the principles of the present disclosure. In the drawings:

FIG. 1 is a schematic diagram illustrating an embodiment of an insurance quoting system;

FIG. 2 is a block diagram illustrating an embodiment of a server in the insurance quoting system of FIG. 1;

FIG. 3 is a flow chart depicting an embodiment of an insurance quoting method; and

FIG. 4 is a diagram illustrating an embodiment of a quote matrix generated by the insurance quoting system of FIG. 1.

### DETAILED DESCRIPTION OF THE DRAWINGS

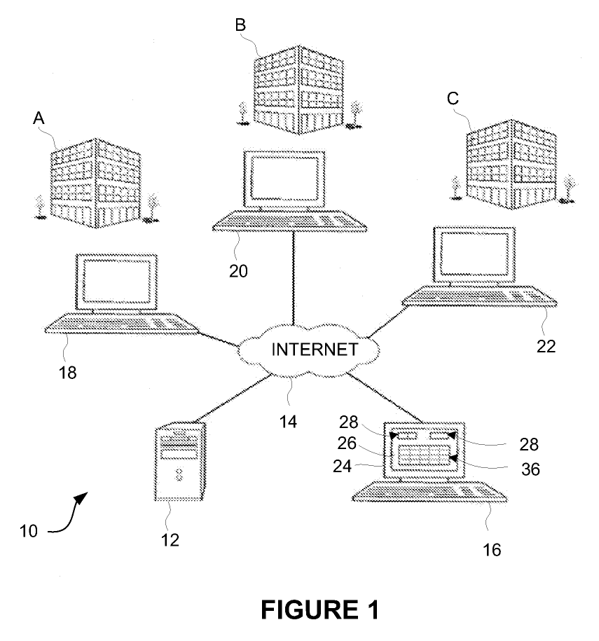

Referring now to FIG. 1, an embodiment of a multidimensional insurance quoting system 10 for providing insurance premium estimates to a user (e.g., consumer, potential customer, insurance agent, insurance broker etc.) is illustrated. As will be more fully explained below, system 10 enables the user to obtain and compare several insurance premium estimates (a.k.a., rate quotes) from different insurance providers. In the embodiment illustrated in FIG. 1, system 10 comprises a server 12 operably coupled through a network 14 to a computer 16 of a user, a computer 18 of insurance provider A, a computer 20 of insurance provider B, and a computer 22 of insurance provider C.

In the embodiment illustrated in FIG. 1, server 12 is a web server of an insurance broker. In some embodiments, server 12 is configured to receive requests through network 14 from a client such as, for example, computer 16. In that regard, server 12 may be equipped to accommodate data formatted as Hypertext Markup Language (HTML) and communicated using a standard communication protocol such as, for example, Hypertext Transfer Protocol (HTTP). Server 12 may be equipped for wireless communication, wired communication, or a combination thereof, over network 14. In some embodiments, server 12 is a computing device other than a web server. For example, server 12 may be a desktop or laptop computer or any other type of computing platform equipped with appropriate hardware and/or software. Also, while server 12 is depicted in FIG. 1 as receiving requests from a single client computer 16, additional client computers 16 may be present and accommodated by server 12. Multiple servers 12 may also be used.

In FIG. 1, network 14 is the Internet, which is a global system of interconnected computer networks that interchange data by packet switching using the standardized Internet Protocol Suite (TCP/IP). In some embodiments, network 14 may be another suitable network such as, for example, a wide area network (WAN), local area network (LAN), intranet, extranet, etc., or any combination thereof. Network 14 is configured to facilitate wireless communication, wired communication, or a combination thereof, between server 12, computer 16, computer 18, computer 20, and computer 22.

In FIG. 1, computer 16 is illustrated as a desktop personal computer (PC). However, it should be understood that computer 16 may be a variety of other network-enabled computing devices such as, for example, a server, laptop computer, notebook computer, tablet computer, personal digital assistant (PDA), wireless handheld device, cellular phone, and/or thin-client. Computer 16 is equipped for wireless communication, wired communication, or a combination thereof, over network 14.

In addition to other various types of software, computer 16 generally includes an Internet browser installed thereon. The browser of computer 16 is generally capable of displaying on a display 24 of the computer 16 an HTML document. In particular, the browser is capable of displaying an interface screen 26 (e.g., in the form of a graphical user interface (GUI)), which is based on the HTML document generated by server 12.

As shown in FIG. 1, interface screen 26 includes one or more input regions 28 where, for example, user profile information, a type of insurance, and one or more parameter values relating to the type of insurance may be input into computer 16 using a keyboard, mouse, or another input device. Input regions 28 may be configured, for example, as blank data fields, drop-down menus providing potential selections, a series of check boxes permitting the user to “check” a listed selection, or otherwise for receiving user profile information, a type of insurance and parameter values.

As used herein, user profile information may include, for example, the name, contact information, date of birth, and social security number of the user. Also, the type of insurance may include, for example, automobile, homeowners, business, disability, health and life insurance. In addition, parameters comprise one or more conditions generally related to a particular type of insurance. For example, parameters may include, for example, a deductible amount for insurance, a coverage amount for insurance, the state of residence of the user, an indication of whether or not the user is a tobacco user, the medical history of the user, the number of automobile accidents the user has been involved in the recent past, the number of traffic violations the user has had during a preceding time frame, the make, model and year of vehicle of the user, the age of the user, and combinations thereof.

In some embodiments, user profile information, a type of insurance, and one or more parameters values are input into computer 16 by a user. The user may be a consumer/customer, an insurance broker/agent on behalf of a user/customer, or other individual. For example, in some embodiments, user profile information, a type of insurance, and one or more parameter values may be entered into computer 16 by an agent or employee of the insurance broker operating server 12. In those embodiments where the agent inputs data and information into computer 16, the agent may receive the information via telephone, electronic mail, facsimile, text message, regular mail, or other suitable transmission method.

Still referring to FIG. 1, the browser of computer 16 is capable of displaying on display 24 a quote matrix 36. As will be more fully explained below, quote matrix 36 includes insurance premium estimates from a number of different insurance providers (e.g., insurance provider A, insurance provider B, and insurance provider C). These insurance premium estimates may be reviewed, compared and considered by the user of computer 16 who may be, for example, contemplating purchasing insurance from one of several different insurance providers based on the provided rate quotes. In some embodiments, the insurance premium estimates of quote matrix 36 may be conveyed to the consumer without employing the browser. For example, quote matrix 36 may be incorporated into an electronic mail message, included as an attachment to an electronic mail message, delivered via facsimile, sent as a text message, accessed through a hyperlink, or communicated using another format or method.

In addition to the above, the browser is capable of displaying a variety of other information on the display 24 of computer 16. Such information includes, but is not limited to, the name and contact information of each insurance provider giving an insurance premium estimate, the input parameters, a button or link permitting the direct purchasing of insurance from a particular insurance provider through the insurance broker, and a button permitting the page to be printed.

Even though generally not affiliated with one another, for the sake of convenience in the discussion below, each of computer 18, computer 20, and computer 22 in FIG. 1 may be collectively referred to as computers 18, 20 and 22 while their affiliated insurance providers may be collectively referred to as respective insurance providers A, B and C. Each of computers 18, 20 and 22 may be a server, web server, some type of personal computer (PC), or other computer device equipped with appropriate hardware and/or software for communication with server 12 through network 14. Also, while three computers 18, 20 and 22 and three insurance providers A, B and C are illustrated in FIG. 1, more or fewer computers and insurance providers may be accessible to server 12 through network 14.

Each of computers 18, 20 and 22 is equipped with software and/or hardware for generating insurance premium estimates based on a given parameter or set of parameter values. For example, a trial-calculation engine capable of calculating insurance premium estimates may be installed on computers 18, 20 and 22. The particular hardware and/or software on each of computers 18, 20 and 22 may be independently developed by the particular insurance provider A, B and C. In other words, each insurance provider A, B and C may have their own proprietary system, method, or algorithm for computing insurance premium estimates. Computers 18, 20 and 22 are each equipped for wireless communication, wired communication, or a combination thereof, over network 14.

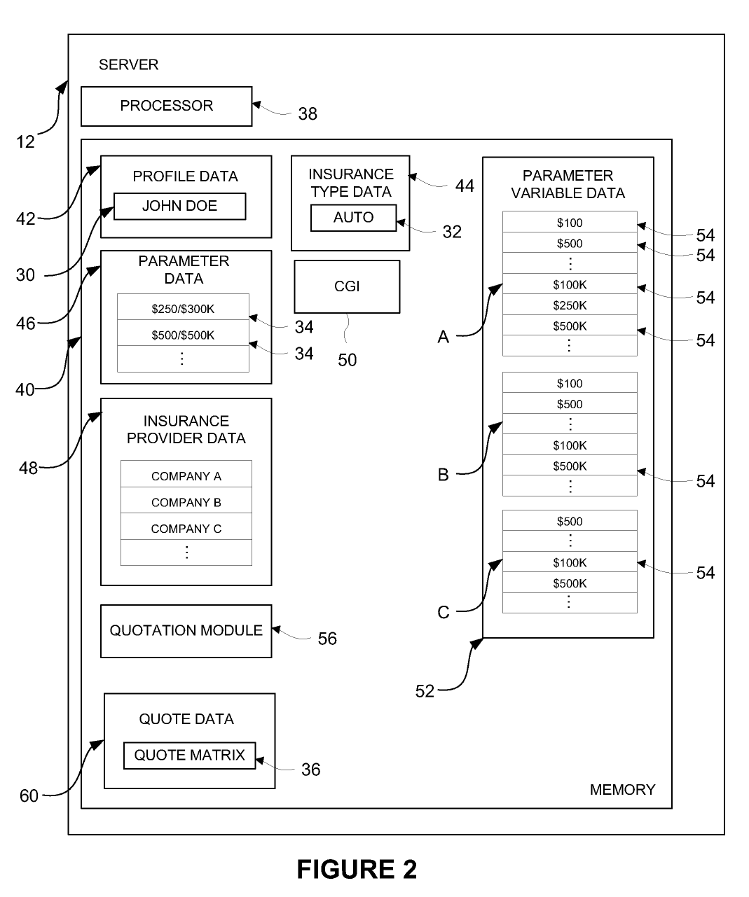

Referring now to FIG. 2, server 12 is illustrated in further detail. As shown, server 12 includes, among other things, a processor 38 and a memory 40. In general, processor 38 processes and/or executes instructions (e.g., software code) and performs logic calculations while memory 40 temporarily or permanently stores information that may be retrieved therefrom. In FIG. 2, memory 40 includes a user profile data 42, insurance type data 44, and parameter data 46.

User profile data 42 comprises information associated with a particular user and/or customer seeking insurance rate quote(s). For example, in FIG. 2 user profile data 42 contains user profile data 30 for consumer John Doe. Insurance type data 44 comprises information associated with a desired type of insurance for which a rate quote is desired. For example, in FIG. 2, insurance type data 44 comprises information associated with an auto type 32 of insurance; however, it should be understood that different types of insurance information may be included/represented. Parameter data comprises information associated with different parameters associated with a particular type of insurance for which a rate quote is desired. For example, in FIG. 2, for an auto type 32 of insurance, parameter data 46 comprises different parameter values 34 corresponding to a deductible amount, a coverage amount, etc., for automobile insurance. Information included in user profile data 42, insurance type data 44 and/or parameter data 46 may be received from or selected by a consumer or an agent of the insurance broker operating server 12 using computer 16. For example, information associated with profile data 42 may be input by a user or broker using computer 16 and stored by server 12 as profile data 42. Further, a particular type of insurance may be selected by a user/broker and, based on the selection, different parameters associated with the selected type of insurance provided to the user/broker for input/selection. The type of insurance and selection of parameter values are stored by server 12 as insurance type data 44 and parameter data 46. It should be understood various types of information associated with the type of insurance and parameter values for a particular type of insurance may be pre-stored in memory 40 and presented to the user/broker through one or more input screens or data entry interfaces.

Memory 40 also includes insurance provider data 48. Insurance provider data 48 comprises information associated with different providers of insurance offerings (e.g., Companies A, B and C). The information stored as insurance provider data 48 may be predefined and stored in memory 40 (e.g., indicating that particular insurance providers offer particular insurance types). It should be understood that insurance provider data 48 may be obtained by server 12 communicating with computers 18, 20 and 22 via network 14 to inquire whether insurance providers (e.g., insurance providers A, B and C) offer a particular type of insurance. In some embodiments, polling of insurance providers may be made to determine the different types of insurance offered by different providers. Information associated with different insurance providers may also be automatically updated in response to updates automatically received from computers 18, 20 and 22 (e.g., without a prompt or request from server 12). In some embodiments, information may be collected from insurance providers according to a predetermined schedule to periodically update information stored in memory 40.

Because of an interface and/or data transferred between server 12, computer 18, computer 20, and computer 22, memory 40 may also include a common gateway interface (CGI) 50. CGI 50 has the ability to receive and process non-standardized data from multiple sources and to output standardized data. In particular, CGI 50 of server 12 may be configured to output a document or data, such as parameter data 46 and profile data 42, in an HTML, XML or any other type of format to facilitate communications with computers 18, 20 and 22, receive information such as rate quotes from computers 18, 20 and 22, and transfer such information to quotation module 56.

Memory 40 also comprises parameter variable data 52 comprising information associated with variables associated with each parameter corresponding to a particular type of insurance. For example, for automobile insurance, one parameter may be a deductible amount. However, each insurance provider may offer different deductible amounts that the consumer may choose. Thus, in this example, the insurance parameter may be a deductible amount, and the parameter variables may be deductible amounts of $100, $250 and $500. As a further example, a parameter may be the coverage limit, and the parameter variables may be coverage limits of $100,000, $250,000, and $500,000. It should be understood that an insurance provider may have predetermined sets of parameter variable values for a particular type of insurance (e.g., offering a set coverage limit having a set deductible amount, having predefined coverage limit amounts, etc.). In FIG. 2, parameter variable data 52 comprises parameter variables 54 for each of the insurance providers A, B and C corresponding to the different parameters of the particular type of insurance. As an example, for insurance company A, the values for variable parameters 54 corresponding to a deductible parameter are $100 and $500, and the values for variable parameters 54 corresponding to a coverage amount are $100,000, $250,000, and $500,000. In FIG. 2, for insurance company B, the values for variable parameters 54 corresponding to a deductible parameter are $100 and $500, and the values for variable parameters 54 corresponding to a coverage amount are $100,000 and $500,000. For insurance company C, the value for variable parameter 54 corresponding to a deductible parameter is $500, and the values for variable parameters 54 corresponding to a coverage amount are $100,000 and $500,000. It should be understood that the values of the parameter variables 54 corresponding to the different insurance providers may match or may be different than a parameter value requested or input by a user for a rate quote.

Parameter variable data 52 may be obtained in a variety of different ways. For example, in some embodiments, parameter variable data 52 may be automatically provided by insurance companies A, B and C. In some embodiments, insurance companies A, B and C may be polled to acquire parameter variable data 52. In some embodiments, parameter variable data 52 may be predefined and/or pre-stored in memory 40 (e.g., based on information acquired from the insurance providers by a broker/agent).

Memory 40 also has stored therein quotation module 56. Quotation module 56 functions to interface with computers 18, 20 and/or 22 and obtain insurance premium estimates/quotes from insurance companies A, B and/or C for inclusion in quote matrix 36. As will be more fully explained below, quotation module 56 generally aggregates and organizes the insurance premium estimates acquired from insurance providers A, B and/or C for inclusion in quote matrix 36. In some embodiments, quotation module 56 is software (e.g., a set of instructions) that, when executed by processor 38, generates and/or otherwise provides interface screen 26, automatically obtains rate quotes from insurance providers, and generates quote matrix 36 based upon rate quotes obtained from insurance providers (e.g., insurance providers A, B and/or C). In other embodiments, quotation module 56 is some combination of software, hardware, and/or firmware. Further, in some embodiments, quotation module 56 automatically varies the values of the parameters, transparently to the user, when interfacing with computers 18, 20 and/or 22 to obtain a variety of different rate quotes. For example, in some embodiments, the parameter value 34 input by a user/broker for a deductible parameter may be $250. In this example, quotation module 56 obtains a rate quote using the requested parameter value (e.g., $250) if available from a particular insurance provider, but also submits additional requests to the insurance provider using different parameter values (e.g., $100 and/or $500) to obtain multiple rate quotes from the insurance provider. The additional requests generally comprise a series of different requests each having one or more different parameter variable values such that a matrix of rate quotes may be obtained for presentation to the user even though the user submitted a request using a single parameter value.

Thus, in operation, a user selects and/or otherwise inputs profile data 42, the type of insurance for which a rate quote is desired (e.g., insurance type data 44) and a value for each of the parameters corresponding to the selected insurance type (e.g., parameter data 46) in interface screen 26 and such information is electronically transmitted to server 12. Quotation module 56 accesses profile data 42, insurance type data 44, and parameter data 46 and formulates and/or otherwise generates a request for a rate quote and submits and/or otherwise electronically communicates the rate quote request to one or more insurance providers. Quotation module 56 receives the rate quote information from the respective insurance providers and stores the rate quote information in memory 40 as quote data 60.

Additionally, transparently to the user and without any user intervention, quotation module 56 formulates and/or otherwise generates additional requests for rate quotes for the user by varying one or more of the parameter values and submitting the corresponding requests to one or more insurance providers. For example, in some embodiments, quotation module 56 revises the deductible parameter value input/selected by the user to another deductible value and submits and/or otherwise communicates the rate quote request to one or more insurance providers (e.g., the same insurance provider that provided the previous rate quote and/or other insurance providers). Quotation module 56 may poll the particular insurance provider to determine a different parameter value offered by the insurance provider and/or access information corresponding to different parameter values (e.g., parameter variable data 52). Quotation module 56 receives the rate quote information from the respective insurance providers for the revised parameter value and stores the rate quote information in memory as 40 as quote data 60. The above process may be repeated for one or more insurance providers for one or more different parameters, thereby generating multiple rate quotes for presentation to the user even though a single parameter value was specified/input by the user (e.g., a single deductible amount or a single coverage amount). The multiple rate quotes are presented and/or otherwise combined to form quote matrix 36. In some embodiments, the user may have the option of selecting to receive a single rate quote based on the input set of parameter values or receiving multiple rate quotes from one or more insurance providers.

In the embodiment illustrated in FIG. 2, quotation module 56, memory 40, and processor 38 reside on server 12. However, in some embodiments, quotation module 56, memory 40, and/or processor 38 may be embodied within computer 16 in lieu of server 12. Also, in some embodiments, either or both of memory 40 and processor 38 may be incorporated into another device and remotely located relative to server 12 and/or computer 16. In some embodiments, quotation module 56 is stored on a tangible, computer-readable medium such as, for example, a compact disk (CD), a digital versatile disk (DVD), which is sometimes referred to as a digital video disk, a flash drive, and the like. Further, it should be understood that quotation module 56, and the information used by quotation module 56 (e.g., parameter variable data 52, parameter data 46, insurance provider data 48) may be located remote from server 12 and/or processor 38.

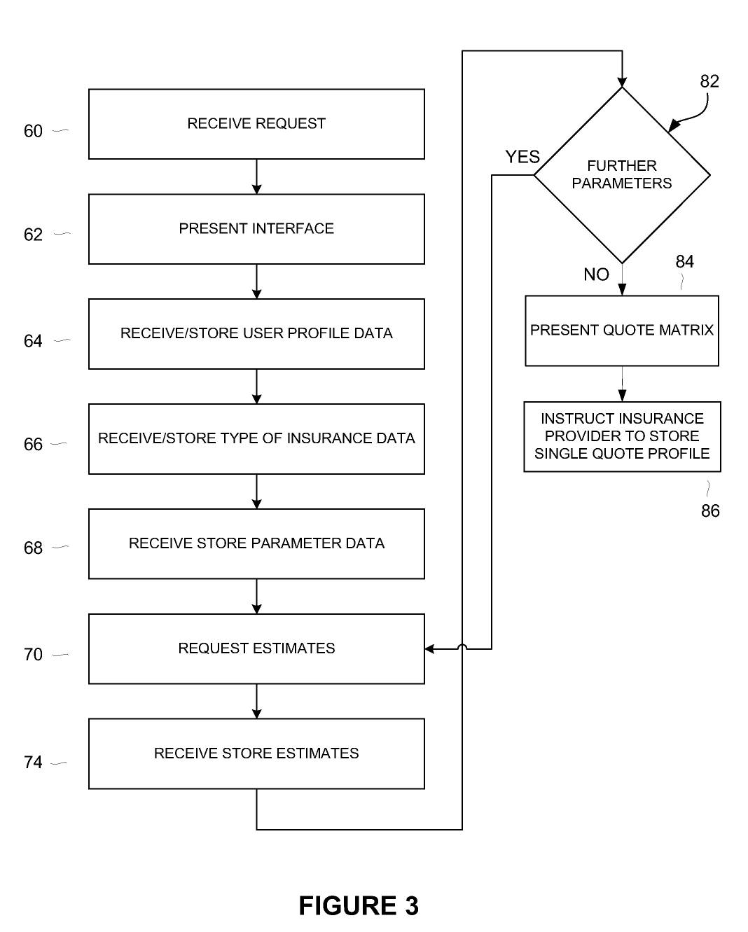

FIG. 3 is a flow diagram illustrating an embodiment of a method for providing insurance premium estimates from insurance providers. At block 60, server 12 receives a service request initiated by the user via the browser on computer 16. The service connection request received by server 12 may be initiated by, for example, the user inputting into the browser on computer 16 the uniform resource locator (URL) of the website of the insurance broker operating server 12.

At block 62 quotation module 56 is executed by processor 38 of server 12 to present the interface screen 26 to the user on display 24 of computer 16. With a keyboard, mouse, or another suitable input device, the user inputs, through input regions 28 of interface screen 26, user profile data 30. Thereafter, user profile data 30 is transmitted through network 14 to server 12. At block 64, server 12 receives and stores user profile data in memory 40.

Quotation module 56 prompts and/or otherwise requests the user to input, through input regions 28 of interface screen 26, an indication of the type of insurance for which a rate quote is desired. Thereafter, the type of insurance associated with the rate quote request is transmitted through network 14 to server 12 and stored as insurance type data 44 in memory 40 at block 66. Quotation module 56 prompts and/or otherwise requests the user to input, through input regions 28 of interface screen 26, one or more parameter values for each of the parameters pertaining to the indicated/selected type of insurance. For example, if the type of insurance selected/indicated is automobile insurance, the user may input a deductible amount of $250 as one parameter value, a desired coverage amount of $300,000 as another parameter value, etc. Thereafter, the parameter values are transmitted through network 14 and stored by quotation module as parameter data 46 in memory 40.

In some embodiments, if a particular parameter value input/selected by the user is not a valid parameter value as predefined and/or otherwise set by a particular insurance provider or within a range stipulated by law, quotation module 56 recognizes the deficiency and automatically revises and/or otherwise adjusts the parameter value. Also, in some embodiments, quotation module 56 informs the user that the parameter value is not valid or not within a range stipulated by law and enables the user to revise and/or adjust the parameter value. For example, in some embodiment, the user may be prompted that the selected/entered parameter value is invalid and various alternate parameter values displayed to the user for selection by the user.

Quotation module 56 generates and/or otherwise formulates a request for a rate quote using the profile data 42 and the parameter data 46 and communicates/transmits the request at block 70 to one or more insurance providers (e.g., communicating with one or more of computers 18, 20 and 22). For example, in some embodiments, quotation module 56 accesses insurance provider data 48 to identify insurance providers offering the particular type of insurance, insurance providers registered with server 12 offering on-line rate quotes, insurance providers offering real-time or near real-time rate quotes, and/or another criteria indicating that the request may/should be transmitted to the corresponding insurance provider. In some embodiments, quotation module 56 may enable a user and/or broker to select and/or otherwise identify the insurance providers to receive the request for rate quote. At block 74, quotation module 56 receives and stores the insurance premium estimates received from the respective insurance providers as quote data 60 in memory 40.

At decisional block 82, quotation module 56 accesses parameter variable data 52 to determine whether different values are available for the user-selected value for a particular insurance parameter (e.g., deductible amount). Quotation module 56 may also poll a particular insurance provider to determine other available parameter values. If other values for a particular parameter may be used with a particular insurance provider, the method proceeds to 70, where quotation module 56 generates and submits another request for a rate quote to the particular insurance provider. It should be understood that the process depicted by blocks 82, 70 and 74 may be repeated for different insurance providers and for different parameters (e.g., deductible amount, coverage amount, etc.). Further, it should be understood that the method depicted by blocks 82, 70 and 74 may be carried out independently of one another as to different insurance providers (e.g., different requests may be submitted to different insurance providers with different parameter values at different times). The requests for rate quotes may also be submitted simultaneously or substantially simultaneously to multiple insurance providers. If no further values for insurance parameters are available, the method proceeds from block 82 to block 84, where quotation module 56 generates quote matrix 36 based on rate quotes received from the insurance providers.

In some embodiments, when quotation module 56 requests rate quotes from insurance providers, quotation module 56 instructs each of insurance providers A, B and C to store only a single consumer/user rate quote profile on computers 18, 20 and 22 (e.g., profile data and a single parameter value set as defined by the parameters values input/selected by the user/broker, such as defined by parameter data 46). Therefore, computers 18, 20, 22 of respective insurance providers A, B and C are not burdened with multiple rate quote profiles for the same consumer. Thus, at block 86, quotation module 56 instructs insurance providers A, B and C to store and/or otherwise save a single quote profile for the user even though multiple rate quotes were obtained for the user.

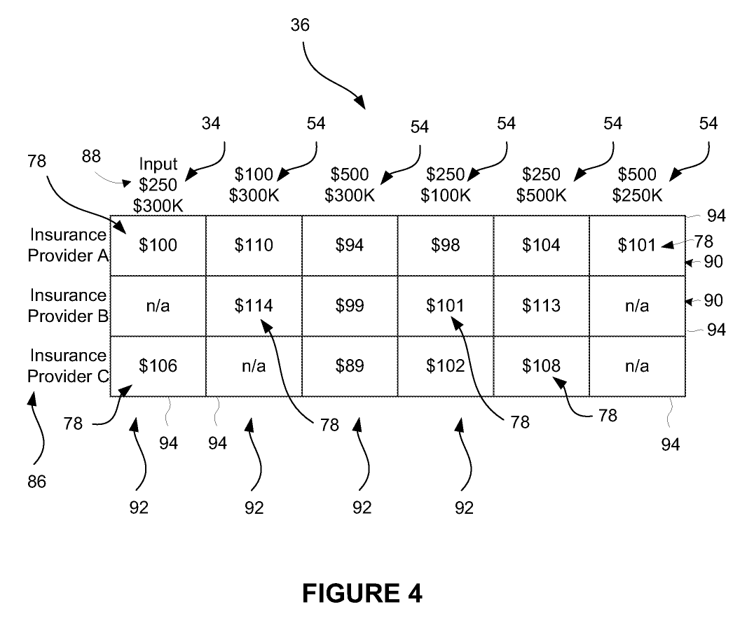

FIG. 4 is a diagram illustrating an embodiment of quote matrix 36 generated by quote module 56. In the illustrated embodiment of FIG. 4, quote matrix 36 is a compilation or collection of insurance premium estimates based upon parameter data 34 and parameter variable data 52 organized in a table or matrix format. In some embodiments, quote matrix 36 may be configured as a chart, graph, or other graphical representation of information. In the embodiment illustrated in FIG. 4, quote matrix 36 has been generated using as parameter data 34 a deductible amount of $250 and a coverage amount of $300,000 for automobile insurance. Based on these entered parameter values 34, several combinations of parameter variable values were determined by quotation module 56 and additional rate quotes obtained without needing the user/broker to re-enter different parameter values. Variable parameter values 54 shown in FIG. 4 include amounts of $100 and $300,000, $500 and $300,000, $250 and $100,000, $250 and $500,000, and $500 and $250,000, which were not input by the user but automatically identified and submitted to respective insurance providers by quotation module 56 independent of user/broker activity or input.

As FIG. 4 illustrates, insurance premium requests based on parameter variable data 52 may be generated by varying one of the parameter values while holding the other parameter values fixed. However, parameter values may be varied, manipulated, or combined in any manner to produce different rate quote requests. In the illustrated embodiment of FIG. 4, quote matrix 36 has insurance providers A, B, C disposed along a vertical axis 86 and parameter values disposed along a horizontal axis 88. The intersection of rows 90 and columns 92 in quote matrix 36 forms a plurality of cells 94. In FIG. 4, cells 94 are filled with insurance premium estimates/quotes 78 based on a particular set of parameter values and the respective insurance provider A, B and C. If no insurance premium estimate/quote is available from a particular insurance providers for a particular set of parameter values, cells 94 may be filled with a “Not Applicable” (N/A) indication to inform the user that a rate quote is not available under those conditions. Empty cells or “N/A”-designated cells may also be indicative of an insurance provider declining coverage for the particular user and/or set of parameter values.

With quote matrix 36 presented via display 24 of computer 16, the user is able to review, compare and consider insurance premium estimates 78 from insurance providers A, B and C. In some embodiments, quotation module 56 indicates which of insurance premium estimates 78 within quote matrix 36 is at the lowest price. For example, quotation module 56 of server 12 may instruct a particular cell 94 containing the lowest price to be highlighted, to flash, to offer a hyperlink linked to an ordering screen, and the like. Likewise, quotation module 56 12 may be configured to provide an indication of which of insurance premium estimates 78 within quote matrix 36 is believed to be the best value.

If satisfied with insurance premium estimates 78 in quote matrix 36, the user may initiate or continue an ordering procedure, provide billing and/or payment information, or otherwise perform some action regarding the provided rate quotes. Thus, embodiments of system 10 enable the user/broker to enter a single set of parameter values to obtain an insurance rate quote while, transparently to the user/broker, multiple rate quotes are obtained so that the user/broker may quickly and conveniently evaluate rate quotes resulting from changes in the parameter values without the need for the user to repeatedly change parameter values and re-enter multiple search requests.

It should be understood that in the described method, certain functions may be omitted, accomplished in a sequence different from that depicted in FIG. 3, or simultaneously performed. Also, it should be understood that the method depicted in FIG. 3 may be altered to encompass any of the other features or aspects as described elsewhere in the specification. Further, embodiments may be implemented in software and can be adapted to run on different platforms and operating systems. In particular, functions implemented by quotation module 56, for example, may be provided as an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium.

What is claimed is:

1. A multidimensional insurance quoting system, comprising:
a quotation module executable by a processor, the quotation module configured to receive a set of parameter values from a user, the quotation module configured to transmit the set of parameter values to at least one insurance provider and obtain a rate quote based on the set of parameter values, the quotation module configured to vary, transparently to the user, at least one value of the set of parameter values and obtain at least one additional rate quote from the insurance provider based on the varied set of parameter values.

2. The system of claim 1, wherein the quotation module is configured to generate a quote matrix incorporating the rate quotes received from the insurance provider.

3. The system of claim 1, wherein the quotation module is configured to access stored parameter variable data to identify a different value available for at least one parameter of the set of parameter values.

4. The system of claim 1, wherein the quotation module is configured to poll the insurance provider to determine a different value available for at least one parameter of the set of parameter values.

5. The system of claim 1, wherein the quotation module is configured to receive profile data associated with the user and transmit the profile data to the at least one insurance provider.

6. The system of claim 1, wherein the varied parameter value comprises a deductible amount.

7. The system of claim 1, wherein the quotation module is configured to receive a selection of a type of insurance from the user for obtaining a rate quote.

8. The system of claim 1, wherein the quotation module is configured to determine which of a plurality of insurance providers to obtain rate quotes from.

9. The system of claim 1, wherein the quotation module is configured to instruct the insurance provider to store a single rate quote profile for the user.

10. A multidimensional insurance quoting method, comprising:
electronically transmitting a set of parameter values to at least one insurance provider;
receiving a rate quote from the at least one insurance provider based on the set of parameter values;
automatically varying, without user intervention, at least one value of the set of parameter values; and
obtaining at least one additional rate quote from the insurance provider based on the varied set of parameter values.

11. The method of claim 10, further comprising generating a quote matrix incorporating the rate quotes received from the insurance provider.

12. The method of claim 10, further comprising accessing stored parameter variable data to identify a different value available for at least one parameter of the set of parameter values.

13. The method of claim 10, further comprising polling the insurance provider to determine a different value available for at least one parameter of the set of parameter values.

14. The method of claim 10, further comprising instructing the insurance provider to store a single rate quote profile based on user profile data transmitted to the insurance provider.

15. A computer program product having stored thereon an instruction set to be executed by a processor, the instruction set, when executed by the processor, causes the processor to:
transmit a set of parameter values to at least one insurance provider;
store a rate quote received from the insurance provider based on the set of parameter values;
automatically vary, without user intervention, at least one value of the set of parameter values; and
obtain at least one additional rate quote from the insurance provider based on the varied set of parameter values.

16. The computer program product of claim 15, wherein the instruction set, when executed by the processor, causes the processor to generate a quote matrix incorporating the rate quotes received from the insurance provider.

17. The computer program product of claim 15, wherein the instruction set, when executed by the processor, causes the processor to access stored parameter variable data to identify a different value available for at least one parameter of the set of parameter values.

18. The computer program product of claim 15, wherein the instruction set, when executed by the processor, causes the processor to poll the insurance provider to determine a different value available for at least one parameter of the set of parameter values.

19. The computer program product of claim 15, wherein the instruction set, when executed by the processor, causes the processor to instruct the insurance provider to store a single rate quote profile for a user.

20. The computer program product of claim 15, wherein the instruction set, when executed by the processor, causes the processor to determine which of a plurality of insurance providers to obtain rate quotes from.
